(19) United States
(12) Patent Application Publication
(10) Pub. No.: US 2003/0081338 A1
(43) Pub. Date: May 1, 2003

(54) Method to determine encroachment at spin stand

(76) Inventors: Wenyao Wang, Singapore (SG); Victor Mh Tan, Singapore (SG)

Correspondence Address: Mitchell K. McCarthy, Seagate Technology LLC, Intellectual Property - OKM280, 10321 West Reno, Oklahoma City, OK, 73127, US

(21) Appl. No.: 10/113,102

(22) Filed: Apr. 1, 2002

Related U.S. Application Data
(60) Provisional application No. 60/335,403, filed on Oct. 31, 2001.

(51) Int. Cl. G11B 5/03; G11B 20/20

(52) U.S. Cl. 360/66; 360/76

(57) ABSTRACT

A method for assessing encroachment at spin stand, an apparatus for carrying out the method and a disc drive configured taking into consideration results of such a method of assessment. In addition to determining encroachment at adjacent tracks, the method provides for the assessment of far track encroachment. The method thus provides a more reliable and more realistic measurement of encroachment, and may also be implemented to establish a relationship between encroachment impact and a specified track distance so as to facilitate quality control of heads in future applications.

### CROSS REFERENCE TO RELATED APPLICATIONS

This application claims the benefit of U.S. Provisional Application No. 60/335,403, filed Oct. 31, 2001.

### FIELD OF THE INVENTION

The present invention relates generally to the manufacture and testing of disc drives. More particularly, the present invention relates to a method of assessing encroachment.

### BACKGROUND OF THE INVENTION

A typical disc drive includes at least one head made up of a writer configured to record data to a disc surface and a reader to retrieve data from the disc surface. The disc surface is usually formatted with concentric tracks for data storage. When the disc is rotated, holding the writer at a more or less fixed position adjacent to the disc surface allows the writer to write data along a track. To write to another track, the writer is repositioned at another radial position relative to the disc surface. Read operations involve similar positioning of the reader and rotation of the disc surface.

It is generally found that as a writer writes data along one track, it will at the same time create erase bands that run alongside that track because of the edge effects of the writer. Wide erase bands have an erasure effect on the tracks immediately adjacent to that track. Various techniques are used to measure erase band widths, of which the “747” test is but one example. The “747” test involves writing two tracks (a test track and a squeeze track) at different distances apart. For the each squeeze track distance apart, measurement of the off track capability is taken at the test track with a background noise presence. Plotting the off track capability against an increasingly closer squeeze track, the off track capability is observed to increase to a hump at a certain distance before it starts to roll off. The erase band width is then derived from the hump.

Encroachment refers to the phenomenon where the writing of data by a writer to a track at the same time corrupts data stored at other tracks. Where wide erase bands affect only the immediately adjacent tracks, encroachment may have an impact on tracks beyond the immediately adjacent tracks, a situation sometimes called far track encroachment. In comparison with erase bands, less is understood of far track encroachment. Nevertheless, because it appears that erase bands form a significant part of encroachment, tests originally designed for measuring erase band widths (for example, the “747” test, the “Write and Erase” test, and the “Triple-Track Profile” test) are generally assumed to be also applicable for measuring encroachment. However, actual measurements obtained in this manner show insufficient correlation to the encroachment characteristics of the writer as well as a lack of repeatability. It is further found that such tests are unable to measure far track encroachment.

It is expected that encroachment will have an increasingly important effect on disc drive performance as the linear density of the disc increases. There is therefore an urgent need for some method of obtaining a more reliable and more realistic measurement of encroachment that can also take into account far track encroachment when present.

The present invention provides a solution to this and other problems, and offers other advantages over the prior art.

### SUMMARY OF THE INVENTION

Embodiments of the present invention provide a method for determining encroachment at spin stand. The method involves steps of writing two tracks as a head travels in a substantially circumferential track-wise direction with respect to a disc, reading pre-erasure data from the disc as the head travels along a scan path, performing a direct current erase as the head travels between the two tracks in the track-wise direction, reading post-erasure data from the disc as the head travels along the scan path, and extracting a measure of encroachment from the pre-erasure data and the post-erasure data. The head is set at a skew angle to the track-wise direction and the two tracks are defined as being an adjacent track distance apart. The scan path is in a cross-track direction that is substantially parallel to a radius of the disc.

The measure of encroachment is given by TSL×TEW/BW, and where TSL is a total signal loss, TEW is a total erasure width and BW is a baseline width. In addition, a relationship between the measure of encroachment and the adjacent track distance may be established.

In addition, there is provided a disc drive having at least one disc and at least one head operably connected to the at least one disc for writing data to and reading data from the at least one disc, and the at least one head has been assessed by the method described in the foregoing.

Thus, the present invention not only provides for the measurement of encroachment, it further allows for measurement of far track encroachment without the need for additional procedures or expensive modifications to currently available equipment. In this and other ways, the present invention provides practical improvement to the manufacturing process of disc drives as well as of disc drive components.

### BRIEF DESCRIPTION OF THE DRAWINGS

FIG. 1 is an exploded perspective view of a disc drive.

FIG. 2 is a partial schematic illustration of a writer at a skewed condition relative to tracks on a disc, showing the geometric relations between the writer and the track pitch.

FIG. 3 is a functional block diagram of a spin stand.

FIGS. 4, 5 and 6 is a flowchart illustrating a method according to an embodiment of the present invention.

FIG. 7 is a diagrammatic presentation of the position of tracks written in accordance with the method of FIG. 4.

FIG. 8 shows signal amplitude versus displacement plotted using data collected using the method of FIG. 4.

FIG. 9 shows a track profile of the head used in the method of FIG. 4.

FIG. 10 shows a signal amplitude versus displacement plot for another test configuration.

FIG. 11 shows encroachment impact versus adjacent track distance.

### DETAILED DESCRIPTION

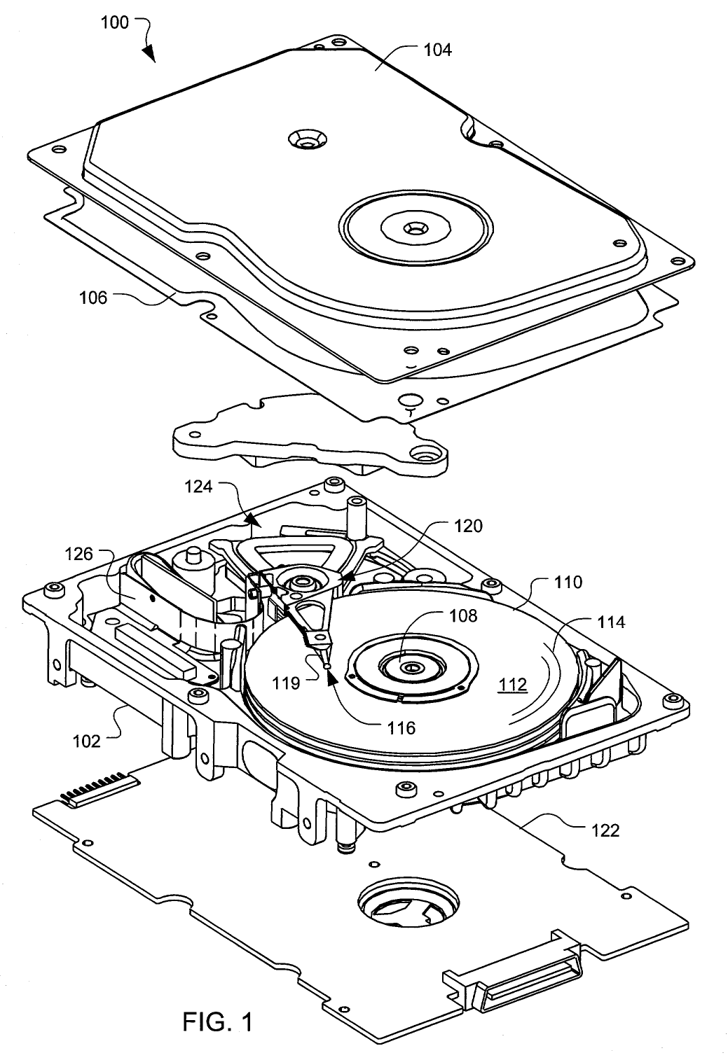

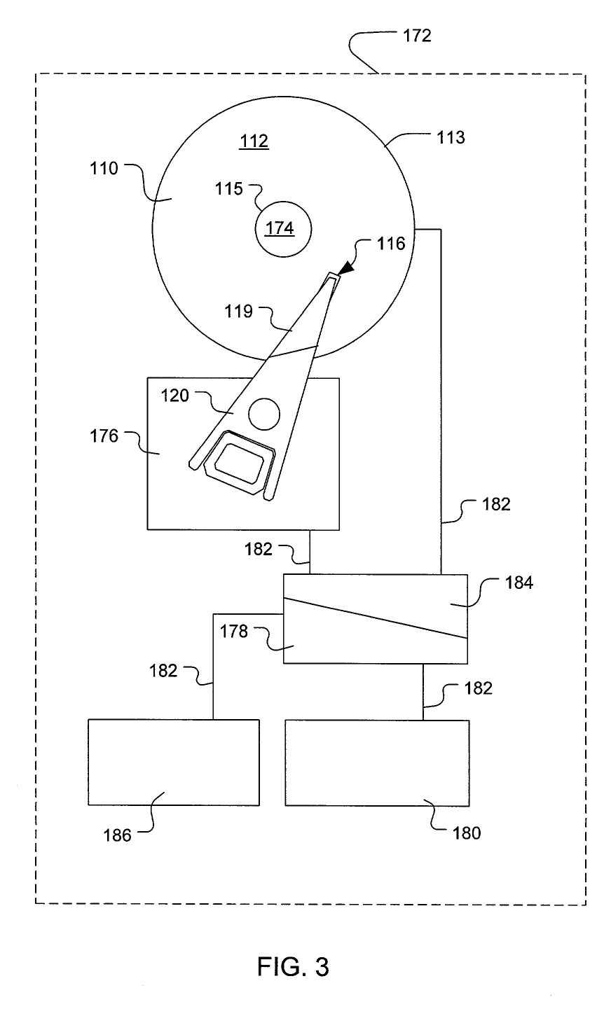

Referring to FIG. 1, a disc drive 100 includes a base plate 102 and a cover 104 forming an enclosure within which various components are assembled. A gasket 106 is sometimes provided for improving the seal between the cover 104 and the base plate 102. Mounted to the base plate 102 is a spindle motor 108 for rotating one or more discs 110 about an axis of rotation, each of which has at least one disc surface 112 formatted in nominally concentric tracks 114 for data storage. Each disc 110 is defined by an outer diameter 113 (FIG. 3) and an inner diameter 115 (FIG. 3). One or more heads (designated generally here by 116 but to be understood to each include a writer 117 and a reader 118) are located at distal ends of one or more suspensions 119 that are in turn supported by an actuator 120 that is also mounted to the base plate 102. Control circuitry, generally found on a printed circuit board 122 attached to the base plate 102 or affixed to the actuator 120, enables a voice coil motor 124 to control the rotational movement of the actuator 120, and thereby bring the heads 116 into proximity with the disc surfaces 112 and locate the heads 116 at desired radial positions. Data and control signals are routed by a flex circuit 126 between the heads 116, the voice coil motor 124 and the printed circuit board 122.

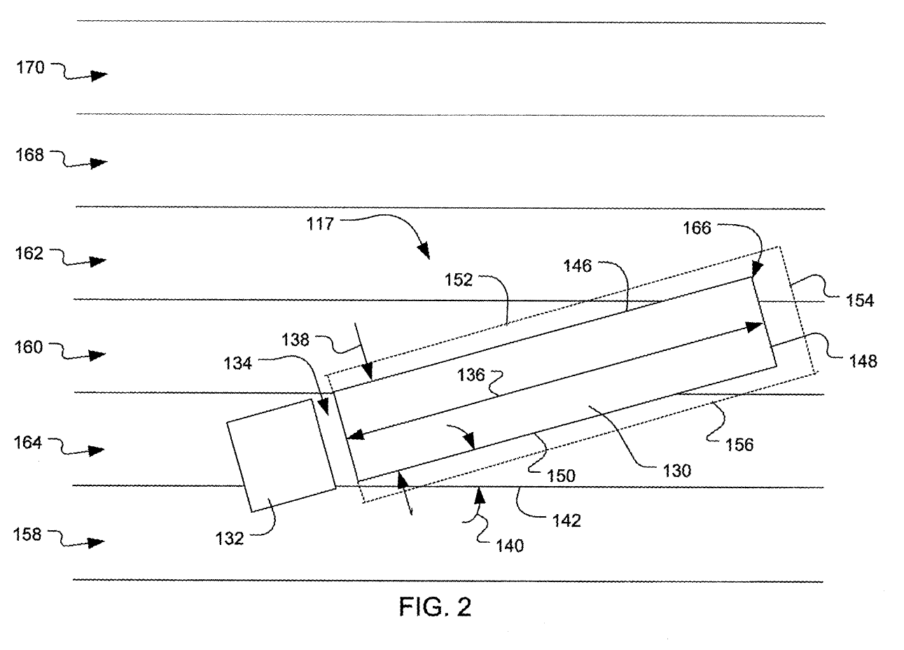

In many disc drive configurations, the use of zone-bit recording and other schemes to maximize the utilization of the disc surface requires the head 116 to be skewed with respect to the tracks 114 for much of the disc surface 112. FIG. 2 shows a writer 117 to include a top pole 130 that is separated from a notch 132 by a writer gap 134. In this example, the top pole length (TPL) 136 is designed to be 1.5 micrometer (μm) and the top pole write gap (TPWG) 138 is designed to be 0.35 μm. Supposing that the skew angle 140 of the writer 128 needs to be set at 18.28 degrees, relative to a tangent 142 of the track, and that the track pitch is about 17.2 micro-inch (μ″), it can be seen from equation (1) below that the tip of the TPL 136 of the writer 117 is positioned at 1.1 track away. Thus it may be expected to have an influence across a width of about 1.1 tracks.

(1.5 μm TPL)*sin(18.28 skew)=0.47 μm=18.8 μ″=1.1 tracks (1)

The magnetic field 152, 154, 156 from the edges 146, 148, 150 of the top pole 130 would extend further than the actual top pole and, as shown in equation (2) below, would have a wider range of impact on adjacent tracks 158, 160, 162 beyond the track 164 at which the writer 117 is intended to be located.

(1.5 μm TPL)*sin(18.28 skew)+0.35 μm/2*cos(18.28 skew)=0.63 μm=25.5 μ″=1.5 tracks (2)

In this example, the top corner 166 of the writer 117 may extend as much as one and a half tracks away from the writer gap center 134. This would at least in part account for the partial reversal of data in the tracks 160 adjacent (or near to) the particular track 164 to which the writer 117 is writing, resulting in encroachment, or more specifically, encroachment at adjacent tracks.

In addition, it is found through the application of finite element modeling techniques that a stray magnetic field from the top corner 166 of the writer 117 may be strong enough to partially encroach or erase data written on adjacent tracks 160 and far adjacent tracks 162. This occurrence is referred to as far track encroachment. That is to say, among the various factors that contribute towards encroachment (which would include encroachment at the adjacent tracks and far track encroachment) there is at least one factor that is less predictable and not easily modeled. Embodiments of the present invention overcome this difficulty by providing a novel method for the measurement of encroachment.

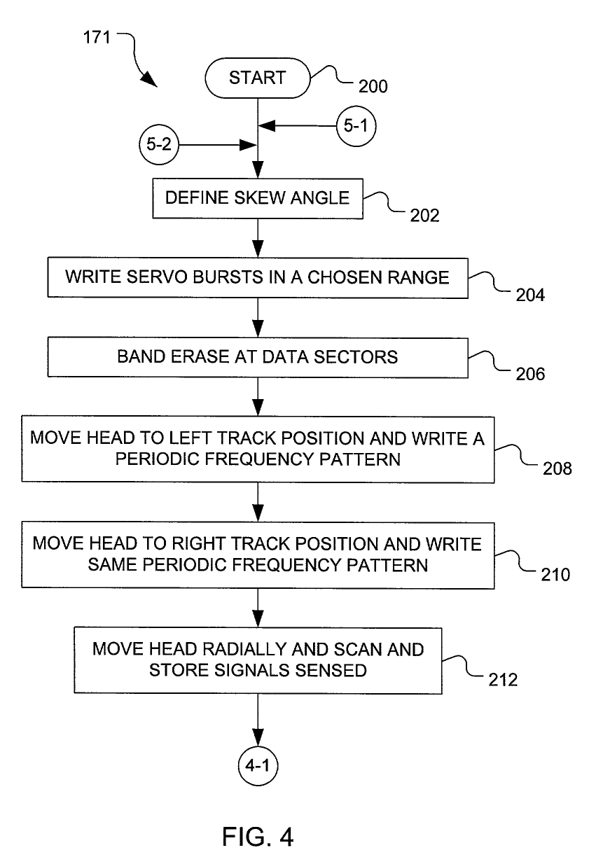

A method 171 (FIG. 4) of determining encroachment in accordance with an embodiment of the present invention is described in the following in the context of a spin stand 172, that is, at a stage of manufacture before the heads 116 are assembled to the rest of the components of the disc drive 100. A functional block diagram of a spin stand 172 such as one that may be used in conjunction with the present invention is shown in FIG. 3. A spin stand motor 174 allows for the mounting and rotation of a disc 110. A support 176 is adapted for positioning an actuator 120 and suspension 119 assembly bearing a head 116 in proximity to the disc surface 112. A servo system 184 made up of a combination of hardware and software is used to eliminate thermal expansion effects of the suspension 119, the disc 110, and the spin stand mechanical parts (such as support 176, spindle motor 174 and actuator 120). A user input module 180 allows a user to set parameters such as the speed of the spin stand motor 174. The user input module is operably connected to a controller 178 via circuitry 182. The controller 178 may incorporate part of the servo system 184. Instructions to carry out a method of the present invention is embodied or carried in the controller 178, which may also be used to analyze the data collected and cause an output module 186 to provide the results of analysis to the user. Alternatively, the controller 178, the servo system 184, the output module 186, and the user input module 180 may be replaced by a host computer system adapted to execute program instructions to perform a method 171 according to the present invention.

Referring to FIG. 4, the process 171 begins at step 200 where at the spin stand a skew angle is defined for the head under assessment at step 202. A larger skew angle 140 may be used to facilitate analysis in some cases, depending on the extent of encroachment and far track encroachment. Alternatively, the skew angle 140 may be set according to the design requirements of the particular disc drive 100. Servo bursts required for guiding all subsequent head movement are written at step 204 for a chosen range, or for a chosen number of tracks, on the disc surface to provide reference points to help keep the head on-track in subsequent operations. This may include the application of known servo systems 184 to compensate for thermal drift in the spin stand.

At step 206, the head is used to perform a whole track direct current (DC) band erase on a disc surface to create a clean area for the following operations. Next, a left track and a right track are written at a predetermined write current and for the same periodic frequency pattern at steps 208, 210.

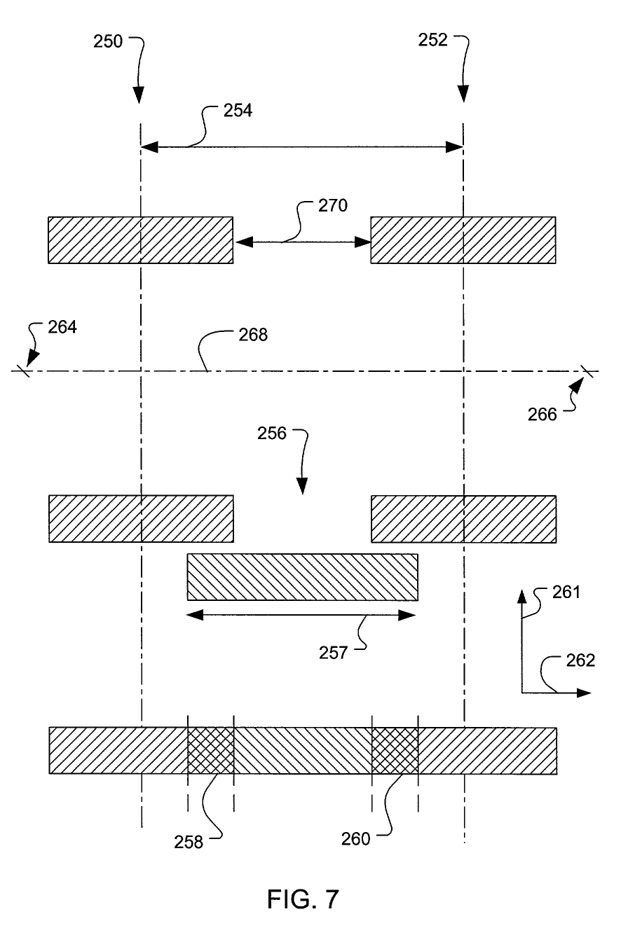

Referring now to FIG. 7, the left track 250 and the right track 252 are written so that they are separated by a specified track distance 254, measured from the center of the left track 250 and the center of the right track 252. The left track 250 is written in a track-wise direction 261 and the right track 252 has been similarly written in the track-wise direction 261.

Varying the specified track distance 254 each time the process 171 is carried out would allow the user to determine the encroachment impact at different distances away from the writer. The specified track distance 254 may vary from values smaller than the track pitch to values larger than the track pitch, according to the design test requirements of the disc drive 100. By setting a relatively large skew angle 140 and a relatively large value for the specified track distance 254, for example, one that is larger than the track pitch, far track encroachment can be characterized. The specified track distance 254 also determines the severity of the interference 258, 260 between a center track 256, the left track 250 and the right track 252. Therefore, using a shorter specified track distance 254 may aid the user by magnifying the encroachment impact and thus facilitate easier study of the phenomenon.

In step 212 (FIG. 4), the reader 118 is next made to travel along a scan path 268 in a cross-track direction 262. The cross-track direction 262 is a direction substantially parallel to a radius of the disc surface 110. Specifically, the reader 118 moving incrementally (in user defined step size) senses signals from the disc surface 112 as it travels from a start point 264, continues across the entire width of the left track 250, bridges the spacing 270 between the right edge of the left track 250 and the left edge of the right track 252, continues across the entire width of the right track 252, and coming to a stop at an end point 266. The signals sensed by the reader 118 are stored as a set of pre-erasure data. Preferably, the signals are processed through a built-in narrow-band filter in the controller 178 of the spin stand 172 to eliminate harmonics and other noise.

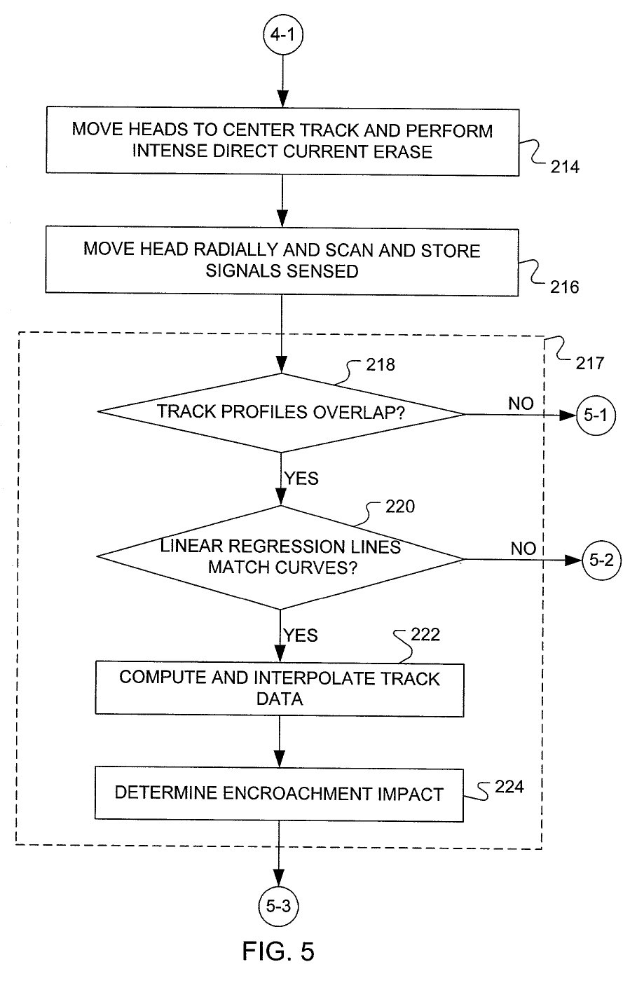

The process 171 then continues to an intense direct current (DC) erase operation 214 (FIG. 5) with the writer 117 in a central position of the spacing 270 or at a mid-point of the specified track distance 254. In other words, the writer 117 is positioned so that it is substantially equidistant from the left track 250 and the right track 252. In this operation 214, the writer 117 travels in the track-wise direction 261 while writing a relatively strong direct current to the center track 256, for one or more than one revolution of the disc 110, and preferably for several revolutions of the disc 110. To enhance the encroachment effects, the intense write erase operation 214 may be carried out with a stronger DC current. As described herein, this and other parameters may be chosen in various combinations.

The reader 118 is next made to travel in the same scan path 268 to obtain a set of post-erasure data in step 216. For example, if the pre-erasure data was collected with the reader 118 traveling in a direction away from the start point 264 towards the end point 266, the post-erasure data is also collected with the reader 118 traveling away from the start point 264 towards the end point 266. In an alternative frame of reference, the reader 118 may be made to travel in a direction away from the point 266 towards the point 264 when collecting the pre-erasure data, in which case the reader will be made to travel in the same direction away from the point 266 towards the point 264 when collecting the post-erasure data.

Making reference to FIG. 7, the start point 264 is a distance to the left of the left track 250 and the end point 266 is a distance to the right of the right track 252.

More specifically, in collecting the set of post-erasure data in step 216, the reader 118 is made to travel from the same start point 264 as that used in collecting the pre-erasure data, and is then made to pass over the entire width of the left track 250, cross the spacing 270, traverse the entire width of the right track 252, and to come to a stop at the same end point 266. The signal sensed by the reader 118 in this reading step 216 is stored as a set of post-erasure data. Preferably, the step size of the movement of the reader 118 in the reading step 216, that is the intervals at which the reader 118 senses signals from the disc surface 112, is also set to be the same as that used in the reading of the pre-erasure data in the reading step 212, such that data is collected from similar locations before and after the intense DC erase operation 214.

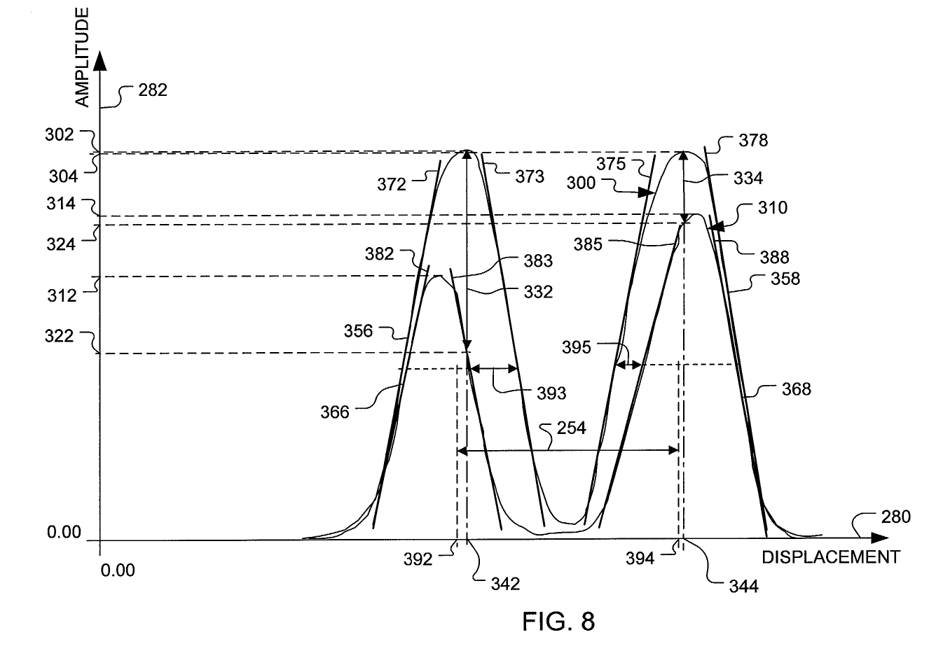

Through carrying out the steps generally designated by 217 in FIG. 5, the pre-erasure data and the post-erasure data is analyzed to extract a measure of encroachment. The set of pre-erasure data and the set of post-erasure data are plotted on the same x-axis 280 of displacement with respect to the start point in the cross-track direction and the same y-axis 282 of signal amplitude, as shown in FIG. 8. A pre-erasure track profile 300 derived from the set of pre-erasure data shows, for increasing displacement, a signal of increasing amplitude coming to a pre-erasure maximum left peak amplitude 302 at a left track displacement 342, followed by a decrease in amplitude, after which the signal again increases to a pre-erasure maximum right peak amplitude 304 at a right track displacement 344. The spacing 270 (FIG. 7) between the left track 250 and the right track 252 accounts for a valley in the pre-erasure track profile 300.

The post-erasure track profile 310 derived from the set of post-erasure data shows the signal amplitude to initially increase with displacement in a manner similar to the pre-erasure track profile 300, but to have a post-erasure maximum left peak amplitude 312 before the signal amplitude decreases. The post-erasure track profile 310 then increases again to a post-erasure maximum right peak amplitude 314. Depending on the specified track distance 254 (FIG. 7), the post-erasure maximum left peak amplitude 312 may be less than or equal to the pre-erasure maximum left peak amplitude 302, and the post-erasure maximum right peak amplitude 314 may be less than or equal to the pre-erasure maximum right peak amplitude 304.

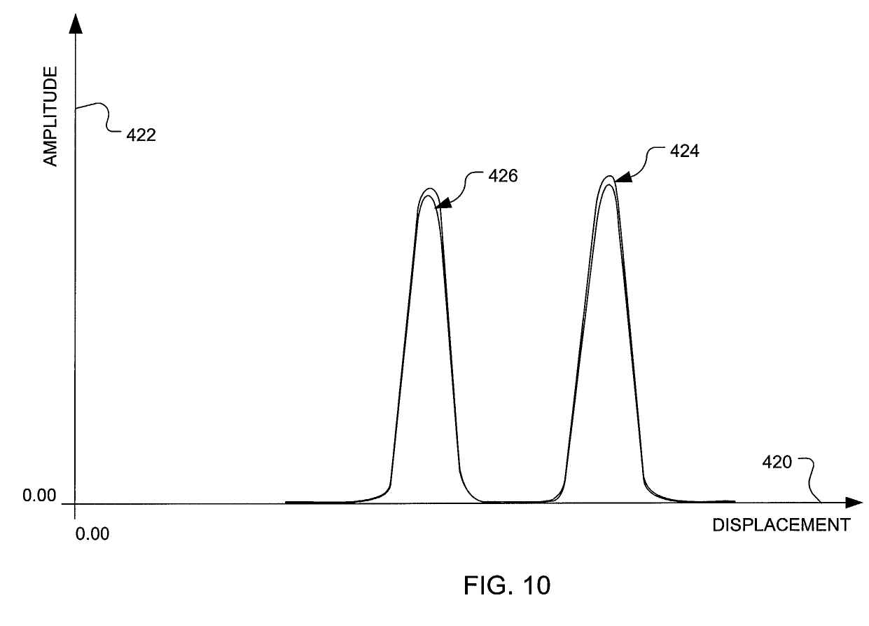

FIG. 10 shows a case where the specified track distance 254 had been defined to be significantly wider than the track pitch. The post-erasure track profile 426 may not show a significant difference from the pre-erasure track profile 424 when plotted against a similar set of y-axis of amplitude 422 and x-axis of displacement 420. It may be desired in such a situation to vary the parameters described above so as to facilitate measurement of encroachment. For example, the process 171 may be repeated with a shorter specified track distance 254.

Turning back to FIGS. 7 and 8, the process 217 preferably includes a step 218 of checking that the pre-erasure track profile 300 and the post-erasure track profile 310 overlap sufficiently. For example, the far left slope 356 of the pre-erasure track profile 300 should preferably generally coincide with the far left slope 366 of the post-erasure track profile 310, and the far right slope 358 of the pre-erasure track profile 300 should preferably generally coincide with the far right slope 368 of the post-erasure track profile 310. If the extent of overlap is deemed insufficient and appears to be indicative of poor servo control, the process 171 is preferably repeated with improved servo control at the spin stand 172.

Alternatively, if the far slopes 356, 358 of the pre-erasure track profile 300 and the far slopes 366,368 of the post-erasure track profile 310 do not overlap, the user may choose to re-define the step size of the reader 118 as it travels along the scan path 268.

Known linear regression techniques are then applied to obtain regression lines 372, 373, 375, 378 along the substantially linear portions of the pre-erasure track profile 300 and to obtain regression lines 382, 383, 385, 388 along the substantially linear portions of the post-erasure track profile 310. If it is found in step 220 that the regression lines do not sufficiently match the substantially linear portions of the pre-erasure track profile and post-erasure track profile, the process 171 is preferably repeated to obtain at least one new set of pre-erasure data and post-erasure data.

Continuing to step 222 of FIG. 5, the displacement of the left track center 392 is taken to be the mid-point between the regression line 372 and the regression line 373 where the signal amplitude is half the pre-erasure maximum left peak amplitude 302. Similarly, the displacement of the right track center 394 is taken to be the mid-point between the regression line 375 and the regression line 378 where the signal amplitude is half the pre-erasure maximum right peak amplitude 304. The difference between the displacement of the right track center 394 and the displacement of the left track center 392 is taken to represent the specified track distance 254.

A left amplitude loss 332 can be read by taking the difference between the pre-erasure maximum left peak amplitude 302 and a post-erasure left amplitude 322 at the left peak displacement 342 of the pre-erasure track profile 300. The post-erasure track profile 310 here shows noticeable signal amplitude loss at the left track 250 and the right track 252, partly because the spacing 270 is narrower than the track width 257, or partly because an intense DC erase 214 was carried out at the center track 257. Similarly, a right amplitude loss 334 can be read by taking the difference between the pre-erasure maximum right peak amplitude 304 and a post-erasure right amplitude 324 at the right peak displacement 344 of the pre-erasure track profile. In this example, the left amplitude loss 332 is more than the right amplitude loss 334. This is mainly due to the writer 117 being skewed towards the left track 250. A total signal loss (TSL) is defined by the sum of the left amplitude loss 332 and the right amplitude loss 334.

The difference in the displacement between regression line 373 and regression line 383 when the signal amplitude of the pre-erasure track profile 300 is half of the pre-erasure maximum left peak amplitude 302 is referred to as the left erasure width 393. The difference in the displacement between regression line 385 and regression line 375 when the signal amplitude of the pre-erasure track profile 300 is half of the pre-erasure maximum right peak amplitude 304 is referred to as the right erasure width 395. A total erasure width (TEW) is defined as the sum of the left erasure width 393 and the right erasure width 395. The TEW can also be based on values taken elsewhere, other than where the signal amplitude is half of the pre-erasure maximum peak values.

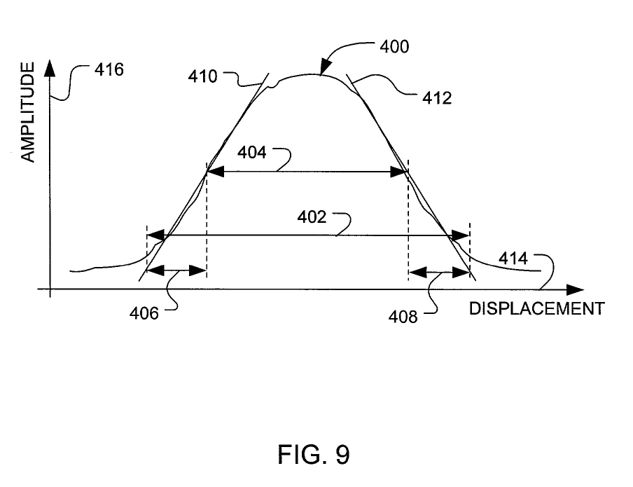

Using methods familiar to a person of ordinary skill in the relevant art and therefore not described here in detail, a standard track profile measurement is taken of the head 116 under assessment to obtain a baseline width 402 (FIG. 9). The standard track profile 400, plotted against a y-axis of amplitude 416 and x-axis of displacement 414 in FIG. 9, shows how the baseline width (BW) 402 is taken to be the sum of the writer width 404 and the read head width 406, 408 with measurements taken from regression lines 410, 412 fitted to the slopes of the standard track profile 400.

According to embodiments of the present invention, encroachment, or encroachment impact, is characterized by multiplying the product of the total signal loss (TSL) and the total erasure width (TEW), and factored by the baseline width (BW) in step 224. This relationship can be expressed as in equation (3) below:

Encroachment Impact=TSL×TEW/BW (3)

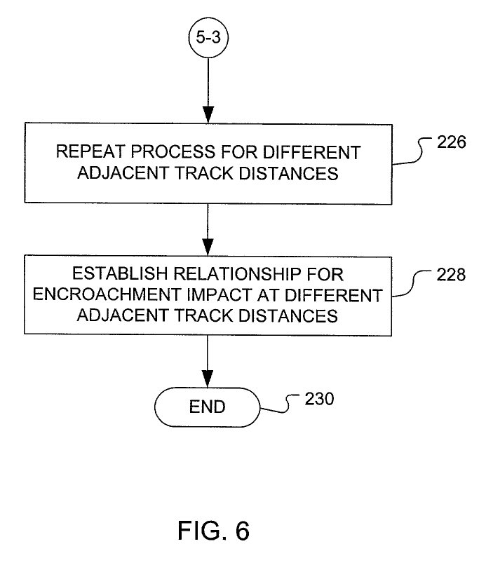

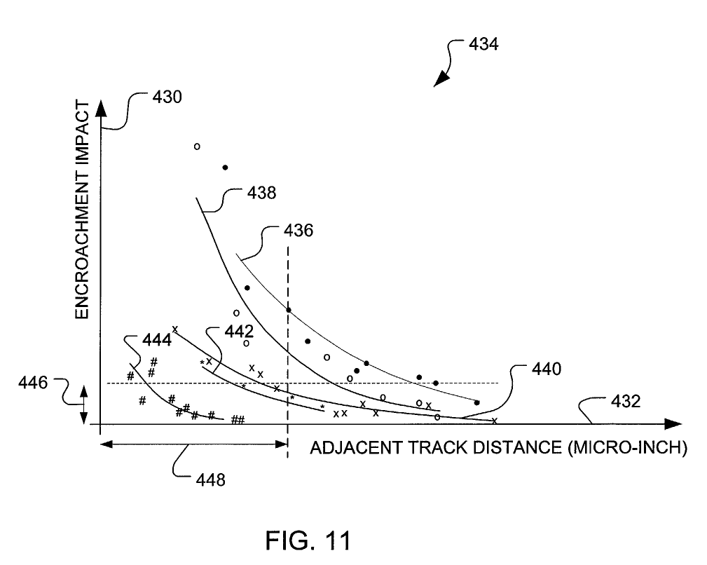

Referring to FIG. 6, the process 171 of assessing encroachment is repeated for different adjacent track distances in process step 226. The process 171 may be completed 230 by establishing the relationship between encroachment and the adjacent track distance 228. One way of doing so is to plot the various encroachment impact values, obtained using the above-described operations, with respect to different adjacent track distances in a graph 434 as shown in the FIG. 11. The relationship curves 436, 438, 440, 442, 444 depict a spectrum that reveals the change of the encroachment with respect to the adjacent track distances. By reading the encroachment impact (y-axis) 430 with reference to the adjacent track distances (x-axis) 432, encroachment at the adjacent tracks and beyond the adjacent tracks can be quantified.

In addition, the graph 434 of FIG. 11 provides a method of checking for any outlying point in a particular test procedure, as well as providing a more effective and more reliable method for future assessment of encroachment because the user can rely on a combination of multiple test data points to make future cut-off judgments. If the encroachment impact is found to be larger than the maximum tolerable encroachment impact 446 within a desired range 448 of adjacent track distances for a particular configuration of a disc drive 100, the head can be identified and rejected or, if practicable, redesigned to reduce the excessive edges fringing effect of the head and thereby reduce the negative impact on the overall performance of the disc drive 100. In this and other ways, the present invention provides practical improvement to the manufacturing process of disc drives and disc drive components.

Furthermore, the graph 434 provides an alternative way of determining the extent to which specified track distances can be targeted before severe encroachment is encountered.

As an option, a method 171 of the present invention may be embodied in a computer program that when executed achieves useful and practical results such as that described in the foregoing.

It can thus be seen that the present invention not only provides for the measurement of encroachment, it allows for measurement of far track encroachment without the need for additional procedures or expensive modifications to currently available equipment. In addition to the various advantages already discussed, the present invention also facilitates the study of encroachment by enabling the user to easily aggravate or emphasize encroachment so that the impact of encroachment is severe enough for easier study.

Alternatively, one embodiment of the present invention may be described as a method 171 for determining encroachment at spin stand 172 including steps of (a) reading 212 pre-erasure data from a disc as a head travels along a scan path 268; (b) erasing 214 with an erase current as the head travels between the two tracks in a track-wise direction 261, the track-wise direction 261 being substantially circumferential with respect to the disc; (c) reading 216 post-erasure data from the disc as the head travels along the scan path; and (d) extracting 217 a measure of encroachment from the pre-erasure data and the post-erasure data. The scan path 268 traverses a first track 250 and a second track 252 in a cross-track direction 262, with the first track 250 and the second track 252 being spaced apart by a specified track distance 254.

The step (d) of extracting 217 the measure of encroachment may further include steps of (e) determining a first amplitude loss 332 representing signal amplitude loss at the first track 250; (f) determining a second amplitude loss 334 representing signal amplitude loss at the second track 252; and (g) obtaining a total signal loss (TSL) from the first amplitude loss 332 and the second amplitude loss 334. Optionally, it may further involve steps of (h) determining a first erasure width 393 representing effect of the erasing step (b) at the first track 250; and (i) determining a second erasure width 395 representing effect of the erasing step (b) at the second track 252; and (j) obtaining a total erasure width (TEW) from the first erasure width 393 and the second erasure width 395. The method may include determining a baseline width (BW) 402 from a track profile measurement. Further, the method may include determining 224 the measure of encroachment from the total signal loss, the total erasure width and the baseline width. The measure of encroachment may be obtained from TSL×TEW/BW.

The method may further involve setting 202 the head at a skew angle to the track-wise direction.

The method optionally involves providing 208, 210 the first track and the second track by writing at least two tracks on the disc. The at least two tracks may be written using a predefined write current and a predefined write frequency.

The reading step (b) and the reading step (d) are optionally carried out with the head reading data at substantially similar incremental read head positions 212, 216. The method may further include storing amplitude signals as a function of the read head positions 212, 216.

The step (c) 214 of performing a direct current erase is optionally carried out using a user-defined direct erase current. The step (c) 214 of performing a direct current erase may be carried out for a user-defined number of disc revolutions.

The extracting step (e) 217 may further include steps of (k) plotting a pre-erasure track profile based on the pre-erasure data against a set of axes, the pre-erasure track profile having a pre-erasure far-left slope and a pre-erasure far-right slope; (l) plotting a post-erasure track profile based on the post-erasure data against the set of axes, the post-erasure track profile having a post-erasure far-left slope and a post-erasure far-right slope; and (m) comparing the pre-erasure track profile with the post-erasure track profile. The extracting step (e) may further include steps 220 of (n) performing linear regression on the pre-erasure track profile to obtain four pre-erasure regression fit lines; (o) if one of the at least one of the four pre-erasure regression fit lines does not substantially match a corresponding slope of the pre-erasure track profile, obtaining new pre-erasure data and post-erasure data; (p) performing linear regression on the post-erasure track profile to obtain four post-erasure regression fit lines; and (q) if at least one of the four post-erasure regression fit lines does not substantially match a corresponding slope of the post-erasure track profile, obtaining new pre-erasure data and new post-erasure data.

The extracting step (e) may further include obtaining new pre-erasure data and new post-erasure data if the pre-erasure far-left slope and the post-erasure far-left slope do not overlap substantially, and if the post-erasure far-right slope and the post-erasure far-right slope do not overlap substantially. The extracting step (e) may further include obtaining the new pre-erasure data and the new post-erasure data after re-defining at least one parameter chosen from a group consisting of the specified track distance, the erase current, a skew angle, a user-defined write current, a user-defined write frequency, and a user-defined number of disc revolutions.

The method optionally includes establishing 228 a relationship between the measure of encroachment and the specified track distance.

One embodiment of the present invention may be described as a disc drive 100 having at least one disc 110; at least one head 116 operably connected to the at least one disc for writing data to and reading data from the at least one disc, in which the at least one head has been assessed by the method 171 described above.

Another embodiment of the present invention may be described as a spin stand 172 having a disc 110 having at least one disc surface 112 formatted with tracks 114 running in a substantially circumferential track-wise direction 261 and a head 116 operably coupled to the disc. The head is configured to write data to the tracks and to read data from the tracks. The spin stand is configured to perform an assessment involving (a) reading 212 pre-erasure data from the disc as the head travels along a scan path 268; (b) erasing 214 with an erase current as the head travels between a first track 250 and a second track 252 in a track-wise direction 261, the track-wise direction being substantially circumferential with respect to the disc; (c) reading 216 post-erasure data from the disc as the head travels along the scan path 268; and (d) extracting 217 a measure of encroachment from the pre-erasure data and the post-erasure data. The scan path 268 traverses the first track 250 and the second track 252 in a cross-track direction, with the first track 250 and the second track 252 being spaced apart by a specified track distance 254.

Optionally, the spin stand 172 may be configured to (e) determine a first amplitude loss 332 representing signal amplitude loss at the first track 250; (f) determine a second amplitude loss 334 representing signal amplitude loss at the second track 252; and (g) obtain a total signal loss (TSL) from the first amplitude loss 332 and the second amplitude loss 334. The spin stand 172 may further be configured to (h) determine a first erasure width 393 representing effect of the erasing step (b) at the first track 250; and (i) determine a second erasure width 395 representing effect of the erasing step (b) at the second track 252; and (j) obtain a total erasure width (TEW) from the first erasure width 393 and the second erasure width 395. Further, the spin stand 172 may be configured to determine the measure of encroachment from the total signal loss, the total erasure width and a baseline width (BW), wherein the baseline width is obtained from a track profile measurement. The spin stand may optionally be configured to obtain the measure of encroachment from TSL×TEW/BW.

The spin stand 172 may be configured to set 202 the head at a skew angle to the track-wise direction.

The spin stand 172 may optionally be configured to store 212, 216 amplitude signals as a function of the incremental read head positions.

The spin stand 172 may be configured such that the assessment further comprises establishing a relationship between the measure of encroachment and the specified track distance.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, although the preferred embodiment described herein is directed to a method carried out at a spin stand, it will be understood by a person skilled in the art to utilize another configuration of equipment to perform the method, without departing from the scope of the present invention.

What is claimed is:

1. A method for determining encroachment at spin stand, the method comprising:
(a) reading pre-erasure data from a disc as a head travels along a scan path;
(b) erasing with an erase current as the head travels in a track-wise direction between a first track and a second track, the track-wise direction being substantially circumferential with respect to the disc;
(c) reading post-erasure data from the disc as the head travels along the scan path; and
(d) extracting a measure of encroachment from the pre-erasure data and the post-erasure data, wherein the scan path traverses the first track and the second track in a cross-track direction, the first track and the second track being spaced apart by a specified track distance.

2. The method of claim 1 wherein the step (d) of extracting the measure of encroachment further includes:
(e) determining a first amplitude loss representing signal amplitude loss at the first track;
(f) determining a second amplitude loss representing signal amplitude loss at the second track; and
(g) obtaining a total signal loss (TSL) from the first amplitude loss and the second amplitude loss.

3. The method of claim 2 further comprising:
(h) determining a first erasure width representing effect of the erasing step (b) at the first track; and
(i) determining a second erasure width representing effect of the erasing step (b) at the second track; and
(j) obtaining a total erasure width (TEW) from the first erasure width and the second erasure width.

4. The method of claim 3 further comprising determining a baseline width (BW) from a track profile measurement.

5. The method of claim 4 further comprising determining the measure of encroachment from the total signal loss, the total erasure width and the baseline width.

6. The method of claim 5 wherein the measure of encroachment is obtained from TSL×TEW/BW.

7. The method of claim 1 further comprising setting the head at a skew angle to the track-wise direction.

8. The method of claim 1 further comprising providing the first track and the second track by writing at least two tracks on the disc.

9. The method of claim 8 wherein the at least two tracks are written using a predefined write current and a predefined write frequency.

10. The method of claim 1 wherein the reading step (b) and the reading step (d) are carried out with the head reading data at substantially similar incremental read head positions.

11. The method of claim 10 further comprising storing amplitude signals as a function of the read head positions.

12. The method of claim 1 wherein the step (c) of performing a direct current erase is carried out using a user-defined direct erase current.

13. The method of claim 1 wherein the step (c) of performing a direct current erase is carried out for a user-defined number of disc revolutions.

14. The method of claim 1 wherein the extracting step (d) further comprises:
(k) plotting a pre-erasure track profile based on the pre-erasure data against a set of axes, the pre-erasure track profile having a pre-erasure far-left slope and a pre-erasure far-right slope;
(l) plotting a post-erasure track profile based on the post-erasure data against the set of axes, the post-erasure track profile having a post-erasure far-left slope and a post-erasure far-right slope; and
(m) comparing the pre-erasure track profile with the post-erasure track profile.

15. The method of claim 14 further comprising:
(n) performing linear regression on the pre-erasure track profile to obtain four pre-erasure regression fit lines;
(o) if one of the four pre-erasure regression fit lines does not substantially match a corresponding slope of the pre-erasure track profile, obtaining new pre-erasure data and post-erasure data;
(p) performing linear regression on the post-erasure track profile to obtain four post-erasure regression fit lines; and
(q) if one of the four post-erasure regression fit lines does not substantially match a corresponding slope of the post-erasure track profile, obtaining new pre-erasure data and new post-erasure data.

16. The method of claim 14 further comprising obtaining new pre-erasure data and new post-erasure data if the pre-erasure far-left slope and the post-erasure far left slope do not overlap substantially, and if the pre-erasure far right slope and the post-erasure far-right slope do not overlap substantially.

17. The method of claim 16 further comprising obtaining the new pre-erasure data and the new post-erasure data after re-defining at least one parameter chosen from a group consisting of the specified track distance, the erase current, a skew angle, a user-defined write current, a user-defined write frequency, and a user-defined number of disc revolutions.

18. The method of claim 1 further comprising establishing a relationship between the measure of encroachment and the specified track distance.

19. A disc drive comprising:
at least one disc;
at least one head operably connected to the at least one disc for writing data to and reading data from the at least one disc, wherein the at least one head has been assessed by the method of claim 1.

20. A spin stand comprising:
a disc having at least one disc surface formatted with tracks running in a substantially circumferential track-wise direction; and
a head operably coupled to the disc, the head being configured to write data to the tracks and to read data from the tracks, wherein the spin stand is configured to perform an assessment comprising:
(a) reading pre-erasure data from the disc as the head travels along a scan path;
(b) erasing with an erase current as the head travels between a first track and a second track in a track-wise direction, the track-wise direction being substantially circumferential with respect to the disc;
(c) reading post-erasure data from the disc as the head travels along the scan path; and
(d) extracting a measure of encroachment from the pre-erasure data and the post-erasure data, wherein the scan path traverses the first track and the second track in a cross-track direction, the first track and the second track being spaced apart by a specified track distance.

21. The spin stand of claim 20 further configured to:
(e) determine a first amplitude loss representing signal amplitude loss at the first track;
(f) determine a second amplitude loss representing signal amplitude loss at the second track; and
(g) obtain a total signal loss (TSL) from the first amplitude loss and the second amplitude loss.

22. The spin stand of claim 21 further configured to:
(h) determine a first erasure width representing effect of the erasing step (b) at the first track; and
(i) determine a second erasure width representing effect of the erasing step (b) at the second track; and
(j) obtain a total erasure width (TEW) from the first erasure width and the second erasure width.

23. The spin stand of claim 22 further configured to determining the measure of encroachment from the total signal loss, the total erasure width and a baseline width (BW), wherein the baseline width is obtained from a track profile measurement.

24. The spin stand of claim 23 configured to obtain the measure of encroachment from TSL×TEW/BW.

25. The spin stand of claim 20 further configured to set the head at a skew angle to the track-wise direction.

26. The spin stand of claim 20 further configured to store amplitude signals as a function of the incremental read head positions.

27. The spin stand of claim 20 wherein the assessment further comprises establishing a relationship between the measure of encroachment and the specified track distance.

28. A spin stand comprising:
a disc;
a head operably coupled to the disc, the head being configured to write data to the disc and to read data from the disc; and
means for determining encroachment characteristics of the head.

29. A spin stand of claim 28 wherein the means provide for the encroachment characteristics to be determined from measurements of amplitude loss at two tracks written on the disc.

30. The spin stand of claim 29 wherein the means provide for adjusting at least one parameter chosen from a group consisting of a distance between the two tracks, an erase current, a skew angle of the head, a write current, a write frequency, and a number of revolutions of the disc, wherein the two tracks are written using the write current and the write frequency, and wherein the erase current contributes to the amplitude loss.
